(19) United States
(12) Patent Application Publication
(10) Pub. No.: US 2021/0399387 A1
(43) Pub. Date: Dec. 23, 2021

(54) BATTERY ASSEMBLY AND ELECTROCHEMICAL DEVICE

(71) Applicant: DONGGUAN AMPEREX TECHNOLOGY LIMITED, Dongguan City, Guangdong Province (CN)

(72) Inventors: Denglong HUANG, Dongguan City, Guangdong Province (CN); Xiaoming CHEN, Dongguan City, Guangdong Province (CN)

(21) Appl. No.: 16/963,017

(22) PCT Filed: Jun. 17, 2020
(86) PCT No.: PCT/CN2020/096491

§ 371 Date: Jul. 17, 2020

(30) Foreign Application Priority Data
Jun. 17, 2019 (CN) 201910520676.6

(51) Int. Cl. H01M 50/503; H01M 50/509; H01M 50/211; H01M 50/553; H01M 50/54; H01M 50/516; H01M 10/48; H01M 50/55; H01M 50/178

(52) U.S. Cl. CPC H01M 50/503; H01M 50/509; H01M 50/211; H01M 50/553; H01M 50/178; H01M 50/516; H01M 10/482; H01M 50/55; H01M 50/54

(57) ABSTRACT

The embodiment of the application relates to a battery assembly and an electrochemical device. The battery assembly includes a first end; a first cell; a second cell, stacked with the first cell, and a first insulator. The first cell is electrically connected with the second cell in series to form a first set of tabs in series, or the first cell is electrically connected with the second cell in parallel to form a first set of tabs in parallel. The first insulator at least covers the first end and being located in a gap of the first series tab assembly or the first parallel tab assembly at the first end. The battery assembly and the electrochemical device provided by the embodiment of the application can realize connection of a soft-package battery with the outside by a simple structure, and meanwhile, has good mechanical resistance and environment resistance.

### CROSS REFERENCE TO RELATED APPLICATIONS

The present application is a National Stage application of PCT international application: PCT/CN2020/096491 which claims the benefit of priority from the Chinese Patent Application NO. 201910520676.6 filed on 17 Jun. 2019, the disclosure of which is hereby incorporated by reference in its entirety.

### BACKGROUND

### 1. Technical Field

The embodiments of the present application relate to the field of batteries, and more particularly to a battery assembly and an electrochemical device.

### 2. Background

Soft-package batteries have already been widely applied to the fields of various electronic products, electric vehicles and the like. In the prior art, connection of tabs of the soft-package battery with external device(s) is achieved by generally adopting a structure of combination of an adapter plate or a support with a copper bar. However, such a technical solution has many disadvantages such as high material cost, complex structure, complicated production process, low production efficiency and the like.

Therefore, regarding how to achieve connection of the tabs of the soft-package battery with the external device(s) through a relatively simple structure and process, there are still a lot of technical problems in the industry that need to be solved urgently.

### SUMMARY

One of the objectives of the embodiments of the present application is to provide a battery assembly and an electrochemical device, which can achieve connection of the soft-package battery with external device(s) through a simple structure, and meanwhile have good mechanical resistance and environment resistance.

A battery assembly provided according to an embodiment of the present application includes a first end; a first cell includes a first tab and a second tab; and, a second cell, stacked with the first cell, includes a third tab and a fourth tab; wherein the first cell and the second cell are electrically connected to form a first series tab assembly by connecting the first tab or the second tab to the third tab or the fourth tab or the first cell and the second cell are electrically connected to form a first parallel tab assembly via the first tab and/or the second tab of the first cell, the second tab includes a first portion extended from a body of the first cell in a direction approximately parallel to a length direction of the first cell, and a second portion extended from an end of the first portion of the second tab, and substantially perpendicular to the first portion of the second tab; the third tab includes a first portion extended from a body of the second cell in a direction approximately parallel to a length direction of the second cell, and a second portion extended from an end of the first portion of the third tab, and substantially perpendicular to the first portion of the third tab; the second portion of the second tab and the second portion of the third tab are stacked and electrically connected; and the battery assembly further includes a first insulator, at least covering the first end and being located in a gap of the first series tab assembly or the first parallel tab assembly at the first end.

In some embodiments of the present application, a connection area takes up from 30% to 95% of the surface of the second portion of the second tab facing the surface of the second portion of the third tab, wherein the connection area is an area of a surface of the second portion of the second tab that is in contact with a surface of the second portion of the second tab; or both the second portion of the second cell and the second portion of the first cell are rectangle, and a distance from a boundary of the connection region to a boundary of the second portion is smaller than about 1 mm.

In some embodiments of the present application, the second tab and the third tab are connected by welding, wherein a hardness of the second tab of the first cell is greater than a hardness of the third tab of the second cell, and the second portion of the second tab is stacked on the second portion of the third tab.

In some embodiments of the present application, the battery assembly further includes one or more second series tab assemblies in series connection with the first series tab assembly, the first series tab assembly being electrically connected with the second series tab assembly by respective tabs thereon, or the second series tab assemblies being electrically connected with one another by respective tabs thereon; or the battery assembly further includes one or more second parallel tab assemblies in series connection with the first parallel tab assembly, the first parallel tab assembly being electrically connected with the second parallel tab assembly by a first connecting piece, or the second parallel tab assemblies being electrically connected with one another by the first connecting piece.

In some embodiments of the present application, the first tab and the fourth tab are respectively connected to a second connecting piece, wherein the second connecting piece is configured for connecting the battery assembly with an external device outside the battery assembly.

In some embodiments of the present application, the battery assembly further includes a voltage detection component located on the connection region.

In some embodiments of the present application, the battery assembly further includes a second end arranged opposite to the first end, and a second insulator at least covering the second end.

In some embodiments of the present application, the first insulator includes a first macromolecule insulating material.

In some embodiments of the present application, a material of the second insulator is the same as a material of the first insulator.

In some embodiments of the present application, the second insulator includes a second macromolecule insulating material.

In some embodiments of the present application, the battery assembly further includes a bonding layer located between the second insulator and the second end of the battery assembly, and a bonding strength between the bonding layer and the second end of the battery assembly is greater than a bonding strength between the first insulator and the first end of the battery assembly.

In some embodiments of the present application, an extending direction of the first tab and the second tab at the first end is defined as a first direction, and the first direction is parallel to a length extension direction of the first cell, a direction opposite to the first direction is defined as a second direction, and the first insulator extends along the second direction and exceeds the first end by at least 1 mm to cover one portion of a main body of the battery assembly.

In some embodiments of the present application, the battery assembly further includes a second end disposed opposite to the first end, a second insulator at least covering the second end, and a bonding layer located between the second insulator and the second end of the battery assembly, the second insulator extending along the first direction and exceeding the second end by at least 1 mm, and the bonding layer and the second insulator extending together to cover the other portion of the main body of the battery assembly, a bonding strength between the bonding layer and the other portion of the main body of the battery assembly being greater than a bonding strength between the first insulator and the one portion of the main body of the battery assembly.

In some embodiments of the present application, the battery assembly further includes a tab insulator, having a first part, and a second part extending from the first part, the second part of the tab insulator being located in the gap of the first series tab assembly or the first parallel tab assembly at the first end.

In some embodiments of the present application, a unit mass of the tab insulator is smaller than a unit mass of the first insulator.

In some embodiments of the present application, a part of the first insulator is located in the tab insulator.

An electrochemical device provided according to another embodiment of the present application includes a battery assembly. The battery assembly includes a first end; a first cell; a second cell, stacked with the first cell, the first cell and the second cell each includes a first tab and a second tab; and wherein one of the first tab or the second tab of the first cell is configured to be electrically connected with one of the first tab or the second tab of the second cell to form a first series tab assembly, or the first tab and the second tab of the first cell are configured to be electrically connected with the first tab and the second tab of the second cell respectively to form a first parallel tab assembly, the first tab and the second tab each includes a first portion and a second portion, the first portion and the second portion are connected and form a bent shape, and the second portion of the first cell and the second portion of the second cell are stacked and electrically connected, the overlapping part of the second portion of the second cell and the second portion of the first cell form a connection region, the battery assembly further includes a first insulator, at least covering the first end and located in a gap of the first series tab assembly or the first parallel tab assembly at the first end.

In some embodiments of the present application, the electrochemical device further includes a tab insulator, having a first part, and a second part extending from the first part, the second part of the tab insulator being located in the gap of the first series tab assembly or the first parallel tab assembly at the first end.

In some embodiments of the present application, a unit mass of the tab insulator is smaller than a unit mass of the first insulator.

In some embodiments of the present application, a part of the first insulator is located in the tab insulator.

The battery assembly and the electrochemical device provided by the embodiments of the present application are capable of realizing connection of the soft-package battery with the external device(s) by a simple structure, and meanwhile, ensure that the soft-package battery has good current overload capacity. Moreover, the battery assembly and the electrochemical device provided by the embodiments of the present application have good mechanical resistance and environment resistance, and have multiple advantages of low material cost, simple production process, high production efficiency and the like.

### BRIEF DESCRIPTION OF THE DRAWINGS

The accompanying drawings required by description about the embodiments of the present application or the prior art will be briefly described below to describe the embodiments of the present application. It is apparent that the accompanying drawings described below are only part of embodiments in the present application. For those skilled in the art, the accompanying drawings of other embodiments can still be obtained according to the structures illustrated in the accompanying drawings without any creative effort.

FIG. 1 shows a structural schematic diagram of a part of a battery assembly according to an embodiment of the present application.

FIG. 2 shows a partially enlarged structure diagram of a part A-A of the battery assembly shown according to FIG. 1.

FIG. 3 shows a structural schematic diagram of a part of a battery assembly according to another embodiment of the present application.

FIG. 4 shows a partially enlarged structure diagram of a part A-A of the battery assembly shown according to FIG. 3.

FIG. 5 shows a partially enlarged structure diagram of a part B-B of the battery assembly shown according to FIG. 3.

FIG. 6 shows a structural schematic diagram of a part of a battery assembly according to another embodiment of the present application.

FIG. 7 shows a structural schematic diagram of a part of a battery assembly according to another embodiment of the present application.

FIG. 8 shows a structural schematic diagram of a part of a battery assembly according to another embodiment of the present application.

FIG. 9 shows a partially enlarged structure diagram of a part A-A of the battery assembly shown according to FIG. 8.

FIG. 10 shows a structural schematic diagram of a part of a battery assembly according to another embodiment of the present application.

FIG. 11 shows a partially enlarged structure diagram of a part A-A of the battery assembly shown according to FIG. 10.

FIG. 12 shows a structural schematic diagram of a part of a battery assembly according to another embodiment of the present application.

FIG. 13 shows a partially enlarged structure diagram of a part A-A of the battery assembly shown according to FIG. 12.

FIG. 14 shows a structural schematic diagram of a part of a battery assembly according to another embodiment of the present application.

FIG. 15 shows a partially enlarged structure diagram of a part A-A of the battery assembly shown according to FIG. 14.

FIG. 16 shows a structural schematic diagram of a part of a battery assembly according to another embodiment of the present application.

FIG. 17 shows a partially enlarged structure diagram of a part A-A of the battery assembly shown according to FIG. 16.

FIG. 18 shows a structure schematic diagram of a battery assembly according to another embodiment of the present application.

FIG. 19 shows a partially enlarged structure diagram of a part A-A of the battery assembly shown according to FIG. 18.

FIG. 20 shows a structure schematic diagram of a battery assembly according to another embodiment of the present application.

FIG. 21 shows a structure schematic diagram of a battery assembly according to another embodiment of the present application;

FIG. 22 shows a schematic diagram before a tab insulator is assembled to the battery assembly according to the embodiment shown in FIG. 21.

FIG. 23 shows a schematic diagram before a tab insulator is assembled to a battery assembly according to another embodiment of the present application.

FIG. 24 shows a schematic diagram after the tab insulator is assembled to the battery assembly according to the embodiment shown in FIG. 23.

### DETAILED DESCRIPTION

Embodiments of this application are described below in detail. Throughout the entire specification of this application, same or similar components or components having same or similar functions are represented by using similar reference numerals. The embodiments related to the accompanying drawings that are described herein are illustrative and schematic, and are used to provide basic understanding for this application. The embodiments of this application should not be construed as limitations to this application.

In this specification, unless otherwise particularly indicated or limited, relativistic wordings such as “central”, “longitudinal”, “lateral”, “front”, “back”, “right”, “left”, “inner”, “outer”, “relatively low”, “relatively high”, “horizontal”, “vertical”, “higher than”, “lower than”, “above”, “below”, “top”, “bottom”, and derived wordings thereof (such as “horizontally”, “downward”, and “upward”) should be construed as referenced directions described in discussion or shown in the accompanying drawings. These relativistic wordings are merely for ease of description, and require constructing or operating this application in a particular direction.

As used in this application, terms “about”, “roughly”, “substantially”, “essentially”, and “approximately” are used for describing and explaining a small variation. When being used in combination with an event or a case, the terms may refer to an example in which the event or case exactly occurs, or an example in which the event or case similarly occurs. For example, when being used in combination with a value, the terms may refer to a variation range being less than or equal to ±10% of the value, for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, if a difference between two values is less than or equal to ±10% of an average value of the values (for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%), it could be considered that the two values are “substantially” the same or “approximate.”

Furthermore, in order to facilitate description, “first”, “second”, “third” and the like may be used herein for distinguishing different components of one figure or a series of figures. “First”, “second”, “third” and the like are not intended to describe corresponding components.

In the present application, otherwise specifically assigned or limited, “dispose”, “connect”, “couple”, “fix” and words similar to them are wide in use, and those skilled in the art may understand the above words according to specific conditions, such as, fixed connection, detachable connection or integrated connection; it may also be mechanical connection or electrical connection; it may also be direct connection or indirect connection through an intermediary structure; and it may also be inner communication of two components.

In the detailed description and the claims, a list of items connected by the term “one of” or similar terms may mean any of the listed items. For example, if items A and B are listed, then the phrase “one of A and B” means only A or only B. In another example, if items A, B, and C are listed, then the phrase “one of A, B and C” means only A; only B; or only C. The item A may include a single component or multiple components. The item B may include a single component or multiple components. The item C may include a single component or multiple components.

In the detailed description and the claims, a list of items connected by the term “at least one of” or similar terms may mean any combination of the listed items. For example, if items A and B are listed, then the phrase “at least one of A and B” means only A; only B; or A and B. In another example, if items A, B and C are listed, then the phrase “at least one of A, B and C” means only A; or only B; only C; A and B (excluding C); A and C (excluding B); B and C (excluding A); or all of A, B and C. The item A may include a single component or multiple components. The item B may include a single component or multiple components. The item C may include a single component or multiple components.

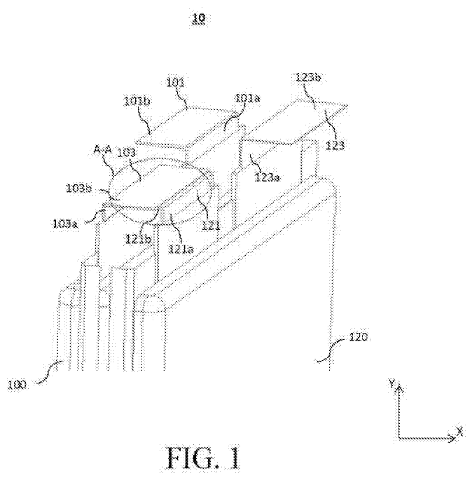

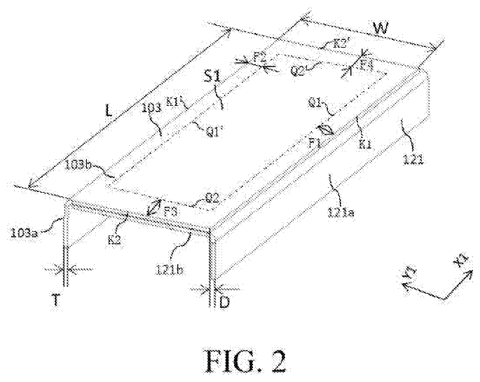

FIG. 1 shows a structural schematic diagram of a part of a battery assembly 10 according to an embodiment of the present application. FIG. 2 shows a partially enlarged structure diagram of a part A-A of the battery assembly 10 shown according to FIG. 1. As shown in FIG. 1, the battery assembly 10 according to an embodiment of the present application includes a first cell 100 and a second cell 120, and the second cell 120 is stacked and electrically connected with the first cell 100.

The first cell 100 includes a first tab 101 and a second tab 103.

The first tab 101 of the first cell 100 includes a first portion 101a extending from a body of the first cell 100 in a direction approximately parallel to a length direction (that is, Y direction shown in FIG. 1) of the first cell 100, and a second portion 101b extending from an end of the first portion 101a of the first tab 101, and being substantially perpendicular to the first portion 101a of the first tab 101. The first portion 101a and the second portion 101b are connected and form a bent shape. The second portion 101b and the first portion 101a roughly form 90 degrees. In other embodiments of the present application, the second portion 101b and the first portion 101a form any proper angle. In the embodiment shown in FIG. 1, the second portion 101b may be formed by only one bending process. In other embodiments of the present application, the second portion 101b may be formed by multiple bending processes, that is, the second portion 101b includes multiple bent sections. The first tab 101 of the first cell 100 is configured to be electrically connected with the external device(s) of the battery assembly 10 through the first portion 101a and/or the second portion 101b.

The second tab 103 of the first cell 100 includes a first portion 103a extending from a body of the first cell 100 in a direction approximately parallel to a length direction (that is, Y direction shown in FIG. 1) of the first cell 100, and a second portion 103b extending from an end of the first portion 103a of the second tab 103, and being substantially perpendicular to the first portion 103a of the second tab 103. The first portion 103a and the second portion 103b are connected and form a bent shape. The second portion 103b and the first portion 103a roughly form 90 degrees. In other embodiments of the present application, the second portion 103b and the first portion 103a form any proper angle. In the embodiment shown in FIG. 1, the second portion 103b is formed by only one bending process. In other embodiments of the present application, the second portion 103b may be formed by multiple bending processes, that is, the second portion 103b includes multiple bent sections.

The second cell 120 includes a third tab 121 and a fourth tab 123.

The third tab 121 of the second cell 120 includes a first portion 121a extending from a body of the second cell 120 in a direction approximately parallel to a length direction (that is, Y direction shown in FIG. 1) of the second cell 120, and a second portion 121b extending from an end of the first portion 121a of the third tab 121, and being substantially perpendicular to the first portion 121a of the third tab 121. The first portion 121a and the second portion 121b are connected and form a bent shape. The second portion 121b and the first portion 121a are substantially perpendicular to each other. In other embodiments of the present application, the second portion 121b and the first portion 121a form any proper angle. In the embodiment shown in FIG. 1, the second portion 121b is formed by only one bending process. In other embodiments of the present application, the second portion 121b may be formed by multiple bending processes, that is, the second portion 121b includes multiple bent sections.

The fourth tab 123 of the second cell 120 includes a first portion 123a extending from a body of the second cell 120 in a direction approximately parallel to a length direction (that is, Y direction shown in FIG. 1) of the second cell 120, and a second portion 123b extending from an end of the first portion 123a of the fourth tab 123, and being substantially perpendicular to the first portion 123a of the fourth tab 123. The first portion 123a and the second portion 123b are connected and form a bent shape. The second portion 123b and the first portion 123a are substantially perpendicular to each other. In other embodiments of the present application, the second portion 123b and the first portion 123a form any proper angle. In the embodiment shown in FIG. 1, the second portion 123b is formed by only one bending process. In other embodiments of the present application, the second portion 123b may be formed by multiple bending processes, that is, the second portion 123b includes multiple bent sections. The fourth tab 123 of the second cell 120 is configured to be electrically connected with the external device(s) by the first portion 123a and/or the second portion 123b of the battery assembly 10.

The second tab 103 of the first cell 100 is electrically connected with the third tab 121 of the second cell 120 by welding to form a first series tab assembly. The first series tab assembly includes: the first tab 101 and the second tab 103 of the first cell 100, and the third tab 121 and the fourth tab 123 of the second cell 120. In other embodiments of the present application, the second tab 103 of the first cell 100 may be electrically connected with the third tab 121 of the second cell 120 in any other proper way to form the first series tab assembly. In other embodiments of the present application, one of the first tab 101 and the second tab 103 of the first cell 100 is configured to be electrically connected with one of the third tab 121 and the fourth tab 123 of the second cell 120 to form the first series tab assembly. That is, the first cell 100 and the second cell 120 may be electrically connected via their tabs to form a series tab assembly. In other embodiments of the present application, the first tab 101 and the second tab 103 of the first cell 100 are configured to be electrically connected with the third tab 121 and the fourth tab 123 of the second cell 120 respectively to form a first parallel tab assembly. That is, the first cell 100 and the second cell 120 may be electrically connected via their tabs to form a parallel tab assembly.

As shown in FIG. 2, the second portion 103b of the second tab 103 of the first cell 100 and the second portion 121b of the third tab 121 of the second cell 120 are stacked and electrically connected. The second portion 103b of the second tab 103 of the first cell 100 is electrically connected with the second portion 121b of the third tab 121 of the second cell 120 by welding, and the second portion 103b of the second tab 103 of the first cell 100 electrically connected with the second portion 121b of the third tab 121 of the second cell 120 forms a connection region S1. That is, the overlapping part of the second portion 121b of the third tab 121 of the second cell 120 and the second portion 103b of the second tab 103 of the first cell 100 forms the connection region S1. More specifically, the connection area S1 is an area of a surface of the second portion 103b of the second tab 103 that is in contact with a surface of the second portion 121b of the third tab 121. The area of the connection region S1, i.e., the area of the surface of the second portion 103b of the second tab 103 which is in contact with the surface of the second portion 121b of the third tab 121 takes up 90% of the area of the surface of the second portion 103b of the second tab 103 facing the surface of the second portion 121b of the third tab 121. The second portion 103b of the second tab 103 of the first cell 100 and the second portion 121b of the third tab 121 of the second cell 120 have substantially the same area. Here, by taking the second portion 103b of the second tab 103 as an example, the second portion 103b has a length L along an X1 direction, and a width W along a Y1 direction, and the area of the second portion 103b is equal to the product of the length L and the width W. In other embodiments of the present application, the area of the connection region S1 takes up from 30% to 95%, preferably, from 60% to 90%, for example, about 65%, about 70%, about 75%, about 80%, about 85%, about 89%, of area of the surface of the second portion 103b of the second tab 103 facing the surface of the second portion 121b of the third tab 121. In other embodiments of the present application, both the second portion 103b of the second tab 103 and the second portion 121b of the third tab 121 are rectangle. Here, by taking the second portion 103b as an example, the second portion 103b has a first boundary K1 along the X1 direction, a second boundary K1′ which is parallel to the first boundary K1, a third boundary K2 along the Y1 direction, and a fourth boundary K2′ which is parallel to the third boundary K2. The connection region S1 is rectangle, and has a first boundary Q1 along the X1 direction, a second boundary Q1′ which is parallel to the first boundary Q1, a third boundary Q2 along the Y1 direction, and a fourth boundary Q2′ which is parallel to the third boundary Q2. The distance from the boundary Q1 to the boundary K1 along the Y1 direction is equal to F1. The distance from the boundary Q1′ to the boundary K1′ along the Y1 direction is equal to F2. The distance from the boundary Q2 to the boundary K2 along the X1 direction is equal to F3. The distance from the boundary Q2′ to the boundary K2′ along the X1 direction is equal to F4. F1, F2, F3 and F4 are smaller than about 1 mm, for example, about 0.7 mm, about 0.5 mm, or about 0.3 mm. In other embodiments of the present application, one of the first tab 101 and the second tab 103 of the first cell 100 is electrically connected with one of the first tab 121 and the second tab 123 of the second cell 120 by welding. The second portion 103b of the second tab 103 of the first cell 100 may be welded with the second portion 121b of the third tab 121 of the second cell 120 through ultrasonic welding, so as to realize maximization of the welding area S1. Compared with other welding processes such as laser linear welding, laser point welding and resistance welding, the ultrasonic welding can realize maximization of the welding area S1, and thus may greatly increase the utilization rate of a tab folded region, so as to promote the current overload capacity of the connection region S1 of the battery assembly 10. In addition, a distance D exists between the boundary of the second portion 103b of the second tab 103 along the X1 direction and the boundary of the first portion 121a of the third tab 121 along the Y direction shown in FIG. 1, and the distance D is a reserved assembly clearance.

In other embodiments of the present application, the second portion 103b of the second tab 103 of the first cell 100 is stacked and electrically connected with the second portion 121b of the third tab 121 of the second cell 120 in any other proper way, so as to jointly define the connection region S1.

The material of the second tab 103 of the first cell 100 is aluminum. The mass of the aluminum in the second tab 103 may exceed about 90% of the total mass, and such kind of second tab 103 is called as an aluminum tab. The material of the third tab 121 of the second cell 120 is copper. The mass of copper in the third tab 121 may exceed about 90% of the total mass, and such kind of third tab 121 is called as a copper tab. The hardness of the second tab 103 of the first cell 100 is greater than the hardness of the third tab 121 of the second cell 120 (that is, the hardness of the aluminum tab is greater than the hardness of the copper tab). Ultrasonic welding may be adopted to dispose the second portion 103b of the second tab 103 on the second portion 121b of the third tab 121, so as to be beneficial for realizing an optimal welding effect because ultrasonic welding is a kind of energy transfer. Where an ultrasonic machine is adopted for the welding, the welding energy required by the tab at one side close to a welding head is smaller than welding energy required by the tab at one side far away from the welding head. Since the aluminum tab requiring relatively small welding energy, the aluminum tab may be placed on the copper tab, i.e., the second tab 103 is placed on the third tab 121 so as to be beneficial for transferring energy to the copper tab at one side far away from the welding head. Thus, after the welding process is completed, a welding imprint on the second portion 103b of the second tab 103 of the first cell 100 caused by the ultrasonic welding is deeper than a welding imprint of the second portion 121b of the third tab 121 of the second cell 120. The welding imprint represents protections and recesses in the Y direction on the surface of the tab caused by the welding.

A current bearing ratio between the first tab 101 and the second tab 103 of the first cell 100 and the third tab 121 and the fourth tab 123 of the second cell

$$120 = \frac{overcurrent capacity}{maximal lasting discharge current} = \frac{\begin{matrix}tab length L * \\ tab thickness T * \\ empirical value E\end{matrix}}{\begin{matrix}maximal lasting \\ discharge current\end{matrix}} ,$$

wherein the tab length L is the length of the second portion of the tab along the X1 direction, for example, the tab length L is the length L of the second portion 103b of the tab 103 as shown in FIG. 2; the tab thickness T is the thickness of the tab 103 as shown in FIG. 2; as for the copper tab, the empirical value E is 8 A/mm²; and as for the aluminum tab, the empirical value E is 5 A/mm². As for large cell energy storage or EV (electric vehicles) cells, the tab thickness T is ≤about 0.5 mm; and for small cell electric tools, E-drive (electric drive), and agricultural unmanned aerial vehicles, the tab thickness T is ≤about 0.3 mm, for example, about 0.1 mm, about 0.15 mm, about 0.2 mm, or about 0.3 mm.

An overcurrent ratio of the connection region

$$S 1 = \frac{effective welding area \times empirical value E}{maximal lasting discharge current} ,$$

wherein the effective welding area is equal to the area of the connection area S1; as for the copper tab, the empirical value E is 8 A/mm²; and as for the aluminum tab, the empirical value E is 5 A/mm². The bearing ratio of the tab and the overcurrent ratio of the connection region S1 are both greater than about 40%.

Compared with use of other welding processes such as laser linear welding, laser point welding or resistance welding, ultrasonic welding is adopted in the embodiment of the present application to weld the tabs so that not only maximization of the welding area is realized thereby the current overload capacity of the battery assembly is promoted, but also a relatively simple connection structure of tabs is realized by only simply considering the welding position relation of tabs of two different materials when welding. Furthermore, the ultrasonic welding process is adopted in the embodiment of the present application so that the tab on each cell is connected with the tab on the cell adjacent to the cell, thereby series connection of multiple mutually stacked cells is realized; then one of respective tabs of two cells, located at the outermost side, among the mutually stacked cells is directly connected to the external device(s) of the battery assembly. Therefore, a simple structure is formed by a simple process to realize connection of the soft-package battery assembly with the external device(s). Therefore, the battery assembly 10 provided by the embodiment of the present application has multiple advantages of low material cost, simple production process, high production efficiency, and the like.

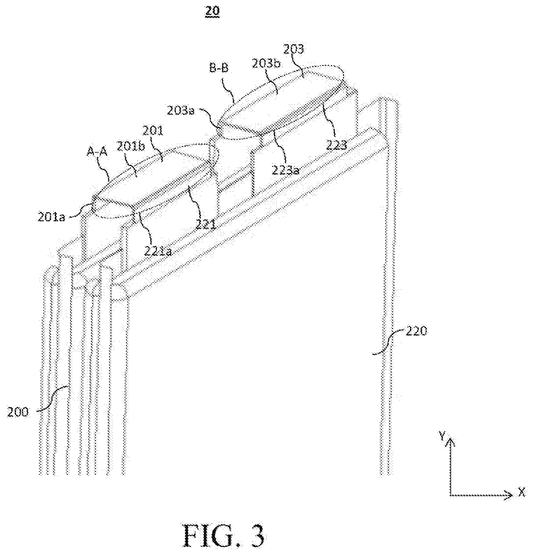

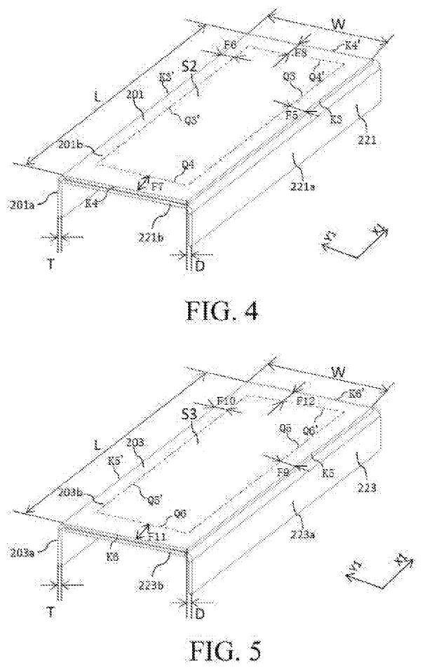

FIG. 3 shows a structural schematic diagram of a part of a battery assembly 20 according to another embodiment of the present application. FIG. 4 shows a partially enlarged structure diagram of a part A-A of the battery assembly 20 shown according to FIG. 3. FIG. 5 shows a partially enlarged structure diagram of a part B-B of the battery assembly 20 shown according to FIG. 3. As shown in FIG. 3 to FIG. 5, the battery assembly 20 according to another embodiment of the present application includes: a first cell 200 and a second cell 220, wherein the second cell 220 is stacked and electrically connected with the first cell 200.

The first cell 200 includes a first tab 201 and a second tab 203.

The first tab 201 of the first cell 200 includes a first portion 201a extending from a body of the first cell 200 in a direction approximately parallel to a length direction (that is, Y direction shown in FIG. 3) of the first cell 200, and a second portion 201b extending from an end of the first portion 201a of the first tab 201, and being substantially perpendicular to the first portion 201a of the first tab 201. The first portion 201a and the second portion 201b are connected and form a bent shape. The second portion 201b and the first portion 201a are substantially perpendicular to each other. In other embodiments of the present application, the second portion 201b and the first portion 201a form any proper angle. In the embodiment shown in FIG. 3, the second portion 201b is formed by only one bending process. In other embodiments of the present application, the second portion 201b may be formed by multiple bending processes, that is, the second portion 201b includes multiple bent sections.

The second tab 203 of the first cell 200 includes a first portion 203a extending from a body of the first cell 200 in a direction approximately parallel to a length direction (that is, Y direction shown in FIG. 3) of the first cell 200, and a second portion 203b extending from an end of the first portion 203a of the second tab 203, and being substantially perpendicular to the first portion 203a of the second tab 203. The first portion 203a and the second portion 203b are connected and form a bent shape. The second portion 203b and the first portion 203a are substantially perpendicular to each other. In other embodiments of the present application, the second portion 203b and the first portion 203a form any proper angle. In the embodiment shown in FIG. 3, the second portion 203b is formed by only one bending process. In other embodiments of the present application, the second portion 203b may be formed by multiple bending processes, that is, the second portion 203b includes multiple bent sections.

The second cell 220 includes a third tab 221 and a fourth tab 223.

The third tab 221 of the second cell 220 includes a first portion 221a extending from a body of the second cell 220 in a direction approximately parallel to a length direction (that is, Y direction shown in FIG. 3) of the second cell 220, and a second portion 221b extending from an end of the first portion 221a of the third tab 221, and substantially perpendicular to the first portion 221a of the third tab 221. The first portion 221a and the second portion 221b are connected and form a bent shape. The second portion 221b and the first portion 221a are substantially perpendicular to each other. In other embodiments of the present application, the second portion 221b and the first portion 221a form any proper angle. In the embodiment shown in FIG. 3, the second portion 221b is formed by only one bending process. In other embodiments of the present application, the second portion 221b may be formed by multiple bending processes, that is, the second portion 221b includes multiple bent sections.

The fourth tab 223 of the second cell 220 includes a first portion 223a extending from a body of the second cell 220 in a direction approximately parallel to a length direction (that is, Y direction shown in FIG. 3) of the second cell 220, and a second portion 223b extending from an end of the first portion 223a of the fourth tab 223, and substantially perpendicular to the first portion 223a of the fourth tab 223. The first portion 223a and the second portion 223b are connected and form a bent shape. The second portion 223b and the first portion 223a roughly form 90 degrees. In other embodiments of the present application, the second portion 223b and the first portion 223a form any proper angle. In the embodiment shown in FIG. 3, the second portion 223b is formed by only one bending process. In other embodiments of the present application, the second portion 223b may be formed by multiple bending processes, that is, the second portion 223b includes multiple bent sections.

The first tab 201 of the first cell 200 is electrically connected with the third tab 221 of the second cell 220 by welding, and the second tab 203 of the first cell 200 is electrically connected with the fourth tab 223 of the second cell 220 by welding, to form a first parallel tab assembly. The first parallel tab assembly includes the first tab 201 and the second tab 203 of the first cell 200, and the third tab 221 and the fourth tab 223 of the second cell 220, wherein the first tab 201 of the first cell 200 and the third tab 221 of the second cell 220 are aluminum tabs, and the second tab 203 of the first cell 200 and the fourth tab 223 of the second cell 220 are copper tabs. In other embodiments of the present application, the first tab 201 of the first cell 200 may be electrically connected with the third tab 221 of the second cell 220 in any other proper way and the second tab 203 of the first cell 200 may be electrically connected with the fourth tab 223 of the second cell 220 in any other proper way, to form the first parallel tab assembly. In other embodiments of the present application, the first tab 201 of the first cell 200 and the third tab 221 of the second cell 220 are copper tabs, and the second tab 203 of the first cell 200 and the fourth tab 223 of the second cell 220 are aluminum tabs.

As shown in FIG. 3 and FIG. 4, the second portion 201b of the first tab 201 of the first cell 200 is stacked and electrically connected with the second portion 221b of the third tab 221 of the second cell 220. The second portion 201b of the first tab 201 of the first cell 200 is stacked and electrically connected with the second portion 221b of the third tab 221 of the second cell 220 by welding. The second portion 201b of the first tab 201 of the first cell 200 electrically connected with the second portion 221b of the third tab 221 of the second cell 220 forms a connection region S2. That is, the overlapping part of the second portion 201b of the first tab 201 of the first cell 200 and the second portion 221b of the third tab 221 of the second cell 220 forms the connection region S2. More specifically, the connection area S2 is an area of a surface of the second portion 201b of the first tab 201 that is in contact with a surface of the second portion 221b of the third tab 221. The area of the connection region S2, i.e., the area of the surface of the second portion 201b of the first tab 201 that is in contact with a surface of the second portion 221b of the third tab 221 takes up 90% of the surface of the second portion 201b of the first tab 201 facing the surface of the second portion 221b of the third tab 221. The second portion 201b of the first tab 201 of the first cell 200 and the second portion 221b of the third tab 221 of the second cell 220 have substantially the same area. Here, by taking the second portion 201b of the first tab 201 as an example, the second portion 201b has a length L along the X1 direction, and a width W along the Y1 direction, and the area of the second portion 201b is equal to the product of the length L and the width W. In other embodiments of the present application, the area of the connection region S2 is from 30% to 95%, preferably, from 60% to 90%, for example, about 65%, about 70%, about 75%, about 80%, about 85%, about 89%, of the area of the second portion 201b of the first tab 201 facing the surface of the second portion 221b of the third tab 221. In other embodiments of the present application, both the second portion 201b of the first tab 201 and the second portion 221b of the third tab 221 are rectangle. Here, by taking the second portion 201b as an example, the second portion 201b has a first boundary K3 along the X1 direction, a second boundary K3′ which is parallel to the first boundary K3, a third boundary K4 along the Y1 direction, and a fourth boundary K4′ which is parallel to the third boundary K4. The connection region S2 is rectangle, and has a first boundary Q3 along the X1 direction, a second boundary Q3′ which is parallel to the first boundary Q3, a third boundary Q4 along the Y1 direction, and a fourth boundary Q4′ which is parallel to the third boundary Q4. The distance from the boundary Q3 to the boundary K3 along the Y1 direction is equal to F5. The distance from the boundary Q3′ to the boundary K3′ along the Y1 direction is equal to F6. The distance from the boundary Q4 to the boundary K4 along the X1 direction is equal to F7. The distance from the boundary Q4′ to the boundary K4′ along the X1 direction is equal to F8. F5, F6, F7 and F8 are smaller than about 1 mm, for example, about 0.7 mm, about 0.5 mm, or about 0.3 mm. In other embodiments of the present application, one of the first tab 201 and the second tab 203 of the first cell 200 is electrically connected with one of the third tab 221 and the fourth tab 223 of the second cell 220 by welding. The second portion 201b of the first tab 201 of the first cell 200 may be welded with the second portion 221b of the third tab 221 of the second cell 220 through ultrasonic welding, so as to realize maximization of the welding area S2. Compared with other welding processes such as laser linear welding, laser point welding or resistance welding, ultrasonic welding is capable of realizing maximization of the welding area S2, and thus greatly increases the utilization rate of the folded region on a tab, and then promotes the current overload capacity of the connection region S2 of the battery assembly 20. In addition, a distance D, which is a reserved assembly clearance, exists between the boundary of the second portion 201b of the first tab 201 along the X1 direction and the boundary of the first portion 221a of the third tab 221 along the Y direction shown in FIG. 3.

In other embodiments of the present application, the second portion 201b of the first tab 201 of the first cell 200 is stacked and connected with the second portion 221b of the third tab 221 of the second cell 220 in any other proper way, so as to jointly define the connection region S2.

As shown in FIG. 3 and FIG. 5, the second portion 203b of the second tab 203 of the first cell 200 is stacked and electrically connected with the second portion 223b of the fourth tab 223 of the second cell 220. The second portion 203b of the second tab 203 of the first cell 200 is stacked and electrically connected with the second portion 223b of the fourth tab 223 of the second cell 220 by welding. The second portion 203b of the second tab 203 of the first cell 200 electrically connected with the second portion 223b of the fourth tab 223 of the second cell 220 forms a connection region S3. That is, the overlapping part of the second portion 203b of the second tab 203 of the first cell 200 and the second portion 223b of the fourth tab 223 of the second cell 220 forms the connection region S3. More specifically, the connection area S3 is an area of a surface of the second portion 203b of the second tab 203 that is in contact with a surface of the second portion 223b of the fourth tab 223. The area of the connection region S3, i.e., the area of the surface of the second portion 203b of the second tab 203 that is in contact with a surface of the second portion 223b of the third tab 223 takes up 90% of the surface of the second portion 203b of the second tab 203 facing the surface of the second portion 223b of the fourth tab 223. The second portion 203b of the second tab 203 of the first cell 200 and the second portion 223b of the fourth tab 223 of the second cell 220 have substantially the same area. Here, by taking the second portion 203b of the second tab 203 as an example, the second portion 203b has a length L along the X1 direction, and a width W along the Y1 direction, and the area of the second portion 203b is equal to the product of the length L and the width W. In other embodiments of the present application, the area of the connection region S3 takes up from 30% to 95%, preferably, from 60% to 90%, for example, about 65%, about 70%, about 75%, about 80%, about 85%, about 89%, of the area of the surface of the second portion 203b of the second tab 203 facing the surface of the second portion 223b of the fourth tab 223. In other embodiments of the present application, both the second portion 203b of the second tab 203 and the second portion 223b of the fourth tab 223 are rectangle. Here, by taking the second portion 203b as an example, the second portion 203b has a first boundary K5 along the X1 direction, a second boundary K5′ which is parallel to the first boundary K5, a third boundary K6 along the Y1 direction, and a fourth boundary K6′ which is parallel to the third boundary K6. The connection region S3 is rectangle, and has a first boundary Q5 along the X1 direction, a second boundary Q5′ which is parallel to the first boundary Q5, a third boundary Q6 along the Y1 direction, and a fourth boundary Q6′ which is parallel to the third boundary Q6. The distance from the boundary Q5 to the boundary K5 along the Y1 direction is equal to F9. The distance from the boundary Q5′ to the boundary K5′ along the Y1 direction is equal to F10. The distance from the boundary Q6 to the boundary K6 along the X1 direction is equal to F11. The distance from the boundary Q6′ to the boundary K6′ along the X1 direction is equal to F12. F9, F10, F11 and F12 are smaller than about 1 mm, for example, about 0.7 mm, about 0.5 mm, or about 0.3 mm. The second portion 203b of the second tab 203 of the first cell 200 may be welded with the second portion 223b of the fourth tab 223 of the second cell 220 through ultrasonic welding, so as to realize maximization of the welding area S3. Compared with other welding processes such as laser linear welding, laser point welding or resistance welding, ultrasonic welding can realize maximization of the welding area S3, and thus greatly increases the utilization rate of a tab folded region, and then promotes the current overload capacity of the connection region S3 of the battery assembly 20. In addition, a distance D, which is a reserved assembly clearance, exists between the boundary of the second portion 203b of the second tab 203 along the X1 direction and the boundary of the first portion 223a of the fourth tab 223 along the Y direction shown in FIG. 3.

In other embodiments of the present application, the second portion 203b of the second tab 203 of the first cell 200 is connected with the second portion 223b of the fourth tab 223 of the second cell 220 in any other proper way, so as to jointly define the connection region S3.

Compared with other welding processes such as laser linear welding, laser point welding or resistance welding, ultrasonic welding can realize the area maximization of the connection regions S2 and S3, so as to increase the utilization rate of the tab folded region, and then promotes the current overload capacity of the connection regions S2 and S3 of the battery assembly 20.

A current bearing ratio between the first tab 201 and the second tab 203 of the first cell 100 and the third tab 221 and the fourth tab 223 of the second cell

$$220 = \frac{overcurrent capacity}{maximal lasting discharge current} = \frac{\begin{matrix}tab length L * \\ tab thickness T * \\ empirical value E\end{matrix}}{\begin{matrix}maximal lasting \\ discharge current\end{matrix}} ,$$

wherein the tab length L is the length of the second portion of the tab along the X1 direction, for example, the tab length L is the length L of the second portion 201b of the tab 201 as shown in FIG. 4; the tab thickness T is the thickness of the tab 201 as shown in FIG. 4; as for the copper tab, the empirical value E is 8 A/mm²; and as for the aluminum tab, the empirical value E is 5 A/mm². As for large cell energy storage or EV (electric vehicles) cells, the tab thickness T is ≤about 0.5 mm; and for small cell electric tools, E-drive (electric drive), and agricultural unmanned aerial vehicles, the tab thickness T is ≤about 0.3 mm, for example, about 0.1 mm, about 0.15 mm, about 0.2 mm, or about 0.3 mm.

An overcurrent ratio of the connection regions S2 and

$$S 3 = \frac{effective welding area \times empirical value E}{maximal lasting discharge current} ,$$

wherein the effective welding area is equal to the area of the connection area S2 and S3 respectively; as for the copper tab, the empirical value E is 8 A/mm²; and as for the aluminum tab, the empirical value E is 5 A/mm². The bearing ratio of the tab and the overcurrent ratio of the connection regions S2 and S3 are both greater than about 40%.

Any one of the first tab 201 of the first cell 200 and the third tab 221 of the second cell 220 may be set to be electrically connected with the external device(s), and any one of the second tab 203 of the first cell 200 and the fourth tab 223 of the second cell 220 is set to be electrically connected with the external device(s), so as to realize electrical connection of the battery assembly 20 shown in FIG. 3 with the external device(s).

In the embodiment of FIG. 3, since the first tab 201 of the first cell 200 and the third tab 221 of the second cell 220 have the same polarity, and the second tab 203 of the first cell 200 and the fourth tab 223 of the second cell 220 have the same polarity, during the ultrasonic welding, the relation of the welding positions of the tabs welded together does not need to be considered. Therefore, according to the embodiment of the present application, a simple structure may be produced through a simple process, to realize the connection of the soft-package battery assembly with the external device(s).

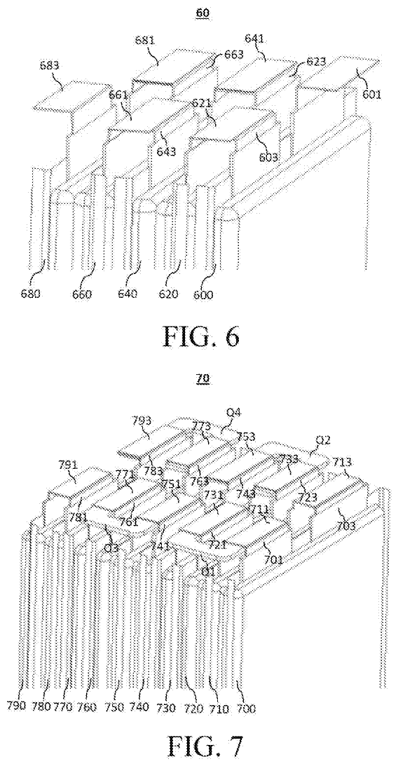

FIG. 6 shows a structural schematic diagram of a part of a battery assembly 60 according to another embodiment of the present application. As shown in FIG. 6, the battery assembly 60 according to another embodiment of the present application includes: a first cell 600, a second cell 620, a third cell 640, a fourth cell 660 and a fifth cell 680 which are stacked and electrically connected with one another.

The first cell 600 includes a first tab 601 and a second tab 603.

The second cell 620 includes a first tab 621 and a second tab 623.

The third cell 640 includes a first tab 641 and a second tab 643.

The fourth cell 660 includes a first tab 661 and a second tab 663.

The fifth cell 680 includes a first tab 681 and a second tab 683.

A setting principle of the shape of the tabs of the first cell 600, the second cell 620, the third cell 640, the fourth cell 660 and the fifth cell 680 is the same as a setting principle of the tabs in the embodiment shown in FIG. 1.

The first tab 601 of the first cell 600 is configured to be electrically connected with the external device(s) of the battery assembly 60. The second tab 603 of the first cell 600 is electrically connected with the first tab 621 of the second cell 620 in a welding process the same as that in the embodiment shown in FIG. 1, to form a first series tab assembly. The first series tab assembly includes the first tab 601 and the second tab 603 of the first cell 600 as well as the first tab 621 and the second tab 623 of the second cell 620. In other embodiments of the present application, the second tab 603 of the first cell 600 may be electrically connected with the first tab 621 of the second cell 620 in any other proper process, so as to form the first series tab assembly. In other embodiments of the present application, one of the first tab 601 and the second tab 603 of the first cell 600 is configured to be electrically connected with one of the first tab 621 and the second tab 623 of the second cell 620, so as to form the first series tab assembly.

The second tab 643 of the third cell 640 is configured to be electrically connected with the first tab 661 of the fourth cell 660 in a welding process the same as that in the embodiment shown in FIG. 1, to form a second series tab assembly. The second series tab assembly includes the first tab 641 and the second tab 643 of the third cell 640 as well as the first tab 661 and the second tab 663 of the fourth cell 660. In other embodiments of the present application, the second tab 643 of the third cell 640 may be electrically connected with the first tab 661 of the fourth cell 660 in any other proper process, so as to form the second series tab assembly. In other embodiments of the present application, one of the first tab 641 and the second tab 643 of the third cell 640 is configured to be electrically connected with one of the first tab 661 and the second tab 663 of the fourth cell 660, so as to form the second series tab assembly.

The second tab 623 of the second cell 620 is electrically connected with the first tab 641 of the third cell 640 in a welding process the same as that in the embodiment shown in FIG. 1. That is, the electrical connection between the first series tab assembly and the second series tab assembly is realized by the second tab 623 of the second cell 620 and the first tab 641 of the third cell 640 which are connected together. Similarly, the second series tab assembly is electrically connected with a third series tab assembly by connecting the second tab 663 of the fourth cell 660 with the first tab 681 of the fifth cell 680, and the third series tab assembly includes the first tab 681 and the second tab 683 of the fifth cell 680.

Therefore, according to the embodiment of the present application, one or more cells may be combined into one or more series tab assemblies, so that multiple second series tab assemblies are welded together through respective tabs thereon to realize electric connection among the multiple series tab assemblies.

FIG. 7 shows a structural schematic diagram of a part of a battery assembly 70 according to another embodiment of the present application. As shown in FIG. 7, the battery assembly 70 according to another embodiment of the present application includes: a first cell 700, a second cell 710, a third cell 720, a fourth cell 730, a fifth cell 740, a sixth cell 750, a seventh cell 760, an eighth cell 770, a ninth cell 780 and a tenth cell 790 which are stacked and electrically connected with one another.

The first cell 700 includes a first tab 701 and a second tab 703.

The second cell 710 includes a first tab 711 and a second tab 713.

The third cell 720 includes a first tab 721 and a second tab 723.

The fourth cell 730 includes a first tab 731 and a second tab 733.

The fifth cell 740 includes a first tab 741 and a second tab 743.

The sixth cell 750 includes a first tab 751 and a second tab 753.

The seventh cell 760 includes a first tab 761 and a second tab 763.

The eighth cell 770 includes a first tab 771 and a second tab 773.

The ninth cell 780 includes a first tab 781 and a second tab 783.

The tenth cell 790 includes a first tab 791 and a second tab 793.

A setting principle of the shape of tabs of the first cell 700, the second cell 710, the third cell 720, the fourth cell 730, the fifth cell 740, the sixth cell 750, the seventh cell 760, the eighth cell 770, the ninth cell 780 and the tenth cell 790 is the same as a setting principle of the tabs in the embodiment shown in FIG. 3.

The first tab 701 of the first cell 700 is electrically connected with the first tab 711 of the second cell 710 in a welding process the same as that in the embodiment shown in FIG. 3, and the second tab 703 of the first cell 700 is electrically connected with the second tab 713 of the second cell 710 in a welding process the same as that in the embodiment shown in FIG. 3, to form a first parallel tab assembly, and the first parallel tab assembly includes the first tab 701 and the second tab 703 of the first cell 700 as well as the first tab 711 and the second tab 713 of the second cell 710.

The first tab 721 of the third cell 720 is electrically connected with the first tab 731 of the fourth cell 730 in a welding process the same as that in the embodiment shown in FIG. 3, and the second tab 723 of the third cell 720 is electrically connected with the second tab 733 of the fourth cell 730 in a welding process the same as that in the embodiment shown in FIG. 3, to form a second parallel tab assembly, and the second parallel tab assembly includes the first tab 721 and the second tab 723 of the third cell 720 as well as the first tab 731 and the second tab 733 of the fourth cell 730.

The first parallel tab assembly is electrically connected with the second parallel tab assembly through a connecting piece Q1. The connecting piece Q1 is a metal bar commonly used in the art, such as a copper bar, a nickel bar, a copper-nickel alloy bar or an aluminum bar.

The first tab 741 of the fifth cell 740 is electrically connected with the first tab 751 of the sixth cell 750 in a welding process the same as that in the embodiment shown in FIG. 3, and the second tab 743 of the fifth cell 740 is electrically connected with the second tab 753 of the sixth cell 750 in a welding process the same as that in the embodiment shown in FIG. 3, to form a third parallel tab assembly, and the third parallel tab assembly includes the first tab 741 and the second tab 743 of the fifth cell 740 as well as the first tab 751 and the second tab 753 of the sixth cell 750.

The second parallel tab assembly is electrically connected with the third parallel tab assembly through a connecting piece Q2. The connecting piece Q2 is a metal bar commonly used in the art, such as a copper bar, a nickel bar, a copper-nickel alloy bar or an aluminum bar.

The first tab 761 of the seventh cell 760 is electrically connected with the first tab 771 of the eighth cell 770 in a welding process the same as that in the embodiment shown in FIG. 3, and the second tab 763 of the seventh cell 760 is electrically connected with the second tab 773 of the eighth cell 770 in a welding process the same as that in the embodiment shown in FIG. 3, to form a fourth parallel tab assembly, and the fourth parallel tab assembly includes the first tab 761 and the second tab 763 of the seventh cell 760 as well as the first tab 771 and the second tab 773 of the eighth cell 770.

The third parallel tab assembly is electrically connected with the fourth parallel tab assembly through a connecting piece Q3. The connecting piece Q3 is a metal bar commonly used in the art, such as a copper bar, a nickel bar, a copper-nickel alloy bar or an aluminum bar.

The first tab 781 of the ninth cell 780 is electrically connected with the first tab 791 of the tenth cell 790 in a welding process the same as that in the embodiment shown in FIG. 3, and the second tab 783 of the ninth cell 780 is electrically connected with the second tab 793 of the tenth cell 790 in a welding process the same as that in the embodiment shown in FIG. 3, to form a fifth parallel tab assembly, and the fifth parallel tab assembly includes the first tab 781 and the second tab 783 of the ninth cell 780 as well as the first tab 791 and the second tab 793 of the tenth cell 790.

The fourth parallel tab assembly is electrically connected with the fifth parallel tab assembly through a connecting piece Q4. The connecting piece Q4 is a metal bar commonly used in the art, such as a copper bar, a nickel bar, a copper-nickel alloy bar or an aluminum bar.

Any one of the second tab 703 of the first cell 700 and the second tab 713 of the second cell 710 may be set to be electrically connected with the external device(s), and any one of the first tab 791 of the tenth cell 790 and the first tab 781 of the ninth cell 780 may be set to be electrically connected with the external device(s), so as to realize electrical connection of the battery assembly 70 shown in FIG. 7 with the external device(s).

Therefore, according to an embodiment of the present application, the tabs on one or more cells may be welded together to be combined into parallel tab assemblies, and the multiple parallel tab assemblies are connected together in series by the connecting pieces, to realize electrical connection among the multiple parallel tab assemblies.

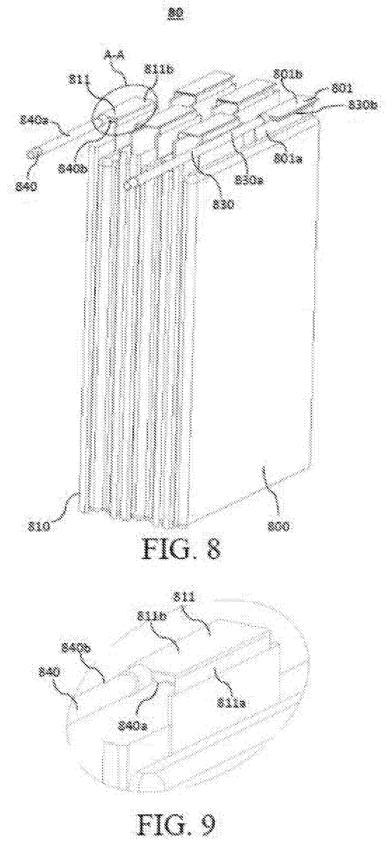

FIG. 8 shows a structural schematic diagram of a battery assembly 80 according to another embodiment of the present application. FIG. 9 shows a partially enlarged structure diagram of a part A-A of the battery assembly 80 shown according to FIG. 8. As shown in FIG. 8 and FIG. 9, the battery assembly 80 shown in FIG. 8 is similar to the embodiment with multiple cells in series connection as shown in FIG. 1 and FIG. 6, and the difference is that: the quantity of cells contained by the battery assembly 80 is different from the quantity of the cell shown in FIG. 1 and FIG. 6; and the battery assembly 80 also includes a connecting piece 830 connected to a first tab 801 of a cell 800 at the outermost side in mutually stacked cells by welding, and a connecting piece 840 connected to a first tab 811 of a cell 810 at the outermost side in the mutually stacked cells by welding. In other embodiments of the present application, the connecting piece 830 and the connecting piece 840 may be respectively connected to the first tab 801 and the first tab 811 in any proper way. The battery assembly 80 is electrically connected with the external device(s) by the connecting piece 830 and the connecting piece 840. In other embodiments of the present application, the connecting piece 830 and the connecting piece 840 are palladium with wires made from any proper material, such as, nickel alloy, copper alloy or aluminum alloy, or the like.

The connecting piece 830 includes a first connection part 830a and a second connection part 830b. The first connection part 830a may be in a cylinder shape. The second connection part 830b may be substantially in a planar shape. The second connection part 830b in the planar shape is stacked and electrically connected with a second portion 801b of the first tab 801. A surface of the second portion 801b of the first tab 801 includes a first part 801c and a second part 801d. The first part 801c is substantially perpendicular to the first portion 801a of the first tab 801 and is closer to the body of the cell 800 than the second part 801d. The second part 801d is substantially perpendicular to the first portion 801a of the first tab 801 and is opposite to the first part 801c. The second connection part 830b in the planar shape is stacked and electrically connected with the first part 801c of the surface of the first tab 801.

The connecting piece 840 includes a first connection part 840a and a second connection part 840b. The first connection part 840a may be in a cylinder shape. The second connection part 840b may be in a substantially planar shape. The second connection part 840b in the planar shape is stacked and electrically connected with a second portion 811b of the first tab 811. The connection manner and position of the second connection part 840b with the second portion 811b is similar as that of the second connection part 830b with the second portion 801b.

Considering that the second connection part 830b and the second connection part 840b are large in area and good in horizontal degree, and have thickness greater than that of the first tab 801 and the first tab 811, the second connection part 830b of the connecting piece 830 and the second connection part 840b of the connecting piece 840 may be respectively welded to below the second portion 801b and the second portion 811b through ultrasonic welding, so as to be convenient for welding and realizing an optimal welding effect.

Therefore, according to an embodiment of the present application, the electrical connection of the battery assembly provided by the present application with the external device(s) is realized by arranging the connecting piece to connect to the tabs on the cell on the outermost side in the battery assembly. Furthermore, connection of the connecting pieces to the tabs on the cell is performed by adopting the ultrasonic welding, so as to ensure that welding positions have a relatively good overcurrent ratio and relatively good welding strength, and the welding process is relatively simple, and thus being beneficial for improvement of the production efficiency.

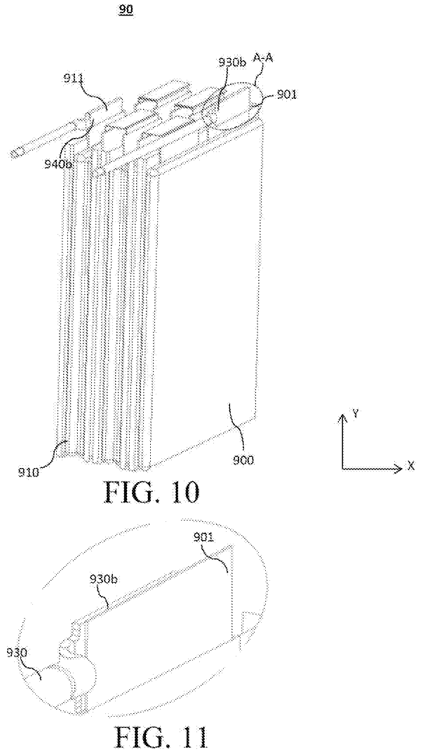

FIG. 10 shows a structural schematic diagram of a battery assembly 90 according to another embodiment of the present application. FIG. 11 shows a partially enlarged structure diagram of a part A-A of the battery assembly 90 shown according to FIG. 10. As shown in FIG. 10 and FIG. 11, the difference between the battery assembly 90 shown in FIG. 10 and the embodiment shown in FIG. 8 is that: a first tab 901 of a cell 900 at the outermost side in mutually stacked cells of the battery assembly 90, and a second connection part 930b of a connecting piece 930 connected with the first tab 901 by welding are arranged along the length direction (that is, the Y direction in FIG. 10) of the battery assembly 90, and a first tab 911 of a cell 910 at the outermost side, and a second connection part 940b of a connecting piece 940 connected with the first tab 911 by welding are arranged along the length direction (that is, the Y direction in FIG. 10) of the battery assembly 90. A vertical welding process may be adopted to respectively weld the second connection part 930b of the connecting piece 930 and the second connection part 940b of the connecting piece 940 to the first tab 901 and the first tab 911. Or, a horizontal welding process may be adopted to form the battery assembly 80 shown in FIG. 8 firstly, and then the second portion 801b of the first tab 801 is bent at the welding position so that the bent first tab 801 and the second connection part 830b of the connecting piece 830 are parallel to the first portion 801a of the first tab 801. When the welding space is relatively small, the horizontal welding operation is more convenient in comparison with the vertical welding. However, one bending process is saved in the vertical welding for forming the battery assembly 90 than the horizontal welding for forming the battery assembly 90. The horizontal welding and the vertical welding may be selected according to specific operation conditions.

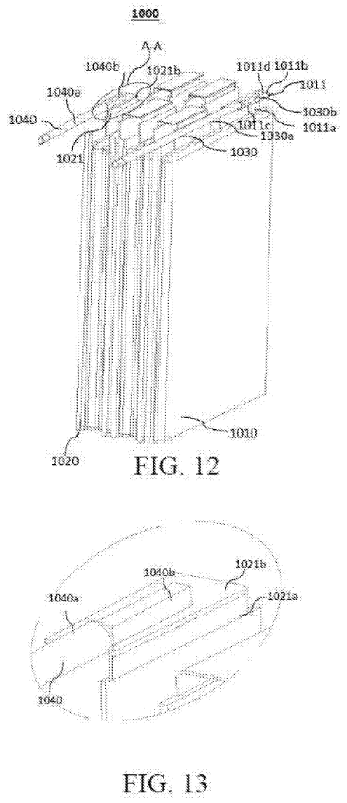

FIG. 12 shows a structural schematic diagram of a battery assembly 1000 according to another embodiment of the present application. FIG. 13 shows a partially enlarged structure diagram of a part A-A of the battery assembly 1000 shown according to FIG. 12. As shown in FIG. 12 and FIG. 13, the difference between the battery assembly 1000 shown in FIG. 12 and the embodiment shown in FIG. 8 is that: a connecting piece 1030 and a connecting piece 1040 are copper cores. The connecting piece 1030 includes a first connection part 1030a and a second connection part 1030b. The first connection part 1030a may be in a cylinder shape. The second connection part 1030b may be substantially in a linear shape. The second connection part 1030b in the linear shape is stacked and electrically connected with a second portion 1011b of a first tab 1011. A surface of the second portion 1011b of the first tab 1011 includes a first part 1011c and a second part 1011d. The first part 1011c is substantially perpendicular to a first portion 1011a of the first tab 1011 and is closer to the body of the cell 1010 relative to the second part 1011d. The second part 1011d is substantially perpendicular to the first portion 1011a of the first tab 1011 and is opposite to the first part 1011c. The second connection part 1030b in the linear shape is stacked and electrically connected with the second part 1011d of the surface of the first tab 1011.

The connecting piece 1040 includes a first connection part 1040a and a second connection part 1040b. The first connection part 1040a may be in a cylinder shape. The second connection part 1040b may be substantially in a linear shape. The second connection part 1040b in the linear shape is stacked and electrically connected with a second portion 1021b of a first tab 1021. The connection manner and position of the second connection part 1040b with the second portion 1021b is similar as that of the second connection part 1030b with the second portion 1011b. In other embodiments of the present application, the connecting piece 1030 and the connecting piece 1040 are connecting lines of any proper material, such as, nickel alloy, copper alloy or aluminum alloy, or the like.

Considering that the second connection part 1030b and the second connection part 1040b have smaller areas relative to the first tab 1011 and the first tab 1021, the ultrasonic welding is adopted to respectively weld the second connection part 1030b of the connecting piece 1030 and the second connection part 1040b of the connecting piece 1040 to the second portion 1011b of the first tab 1011 and the second portion 1021b of the first tab 1021, so as to be beneficial for welding. Welding imprints of the second connection part 1030b and the second connection part 1040b after welding are deeper than welding imprints of the second portion 1011b and the second portion 1021b. The welding imprint represents protections and recesses in the Y direction on the surface of the tab and the second connection part caused by the welding.

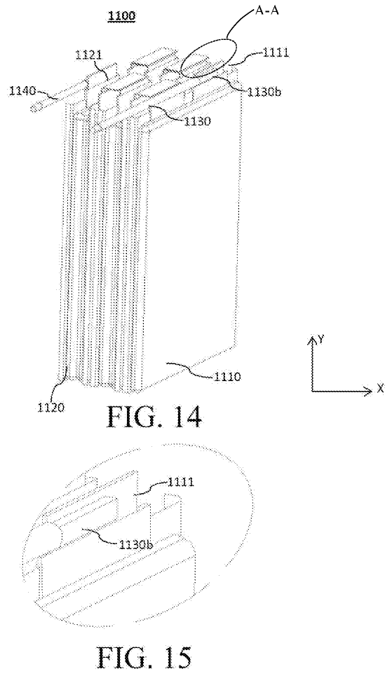

FIG. 14 shows a structural schematic diagram of a battery assembly 1100 according to another embodiment of the present application. FIG. 15 shows a partially enlarged structure diagram of a part A-A of the battery assembly 1100 shown according to FIG. 14. As shown in FIG. 14 and FIG. 15, the difference between the battery assembly 1100 shown in FIG. 14 and the embodiment shown in FIG. 12 is that: a first tab 1111 of a cell 1110 at the outermost side in mutually stacked cells of the battery assembly 1100, and a second connection part 1130b in the linear shape of a connecting piece 1130 connected with the first tab 1111 by welding are arranged along the length direction (that is, the Y direction in FIG. 14) of the battery assembly 1100, and a first tab 1121 of a cell 1120 at the outermost side, and a second connection part in the linear shape (not shown in the figure) of a connecting piece 1140 connected with the first tab 1121 by welding are arranged along the length direction (that is, the Y direction in FIG. 14) of the battery assembly 1100. A vertical welding process may be adopted to respectively weld the second connection part 1130b of the connecting piece 1130 and the second connection part in the linear shape (not shown in the figure) of the connecting piece 1140 to the first tab 1111 and the first tab 1121, wherein the vertical welding means that when welding the second connection part, the connection surface between the second connection part and the tab is parallel to the Y direction in FIG. 14. Or, a horizontal welding process may be adopted to form the battery assembly 1000 shown in FIG. 12 firstly, and then the second portion 1011b of the first tab 1011 is bent at the welding position, so that the bent first tab 1011 and the second connection part 1030b of the connecting piece 1030 are parallel to a first portion 1011a of the first tab 1011, wherein the horizontal welding means that when welding the second connection part, the connection surface between the second connection part and the tab is parallel to the X direction in FIG. 14. When the welding space is relatively small, the horizontal welding operation is more convenient in comparison with the vertical welding. However, one bending process is saved in the vertical welding for forming the battery assembly 1100 than the horizontal welding for forming the battery assembly 1100. The horizontal welding and the vertical welding may be selected according to specific operation conditions.

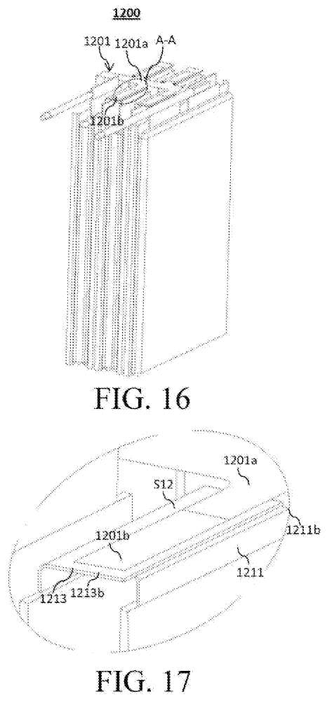

FIG. 16 shows a structural schematic diagram of a battery assembly 1200 according to another embodiment of the present application. FIG. 17 shows a partially enlarged structure diagram of a part A-A of the battery assembly 1200 shown according to FIG. 16. As shown in FIG. 16 and FIG. 17, the difference between the battery assembly 1200 shown in FIG. 16 and the embodiment shown in FIG. 14 is that: the battery assembly 1200 also includes a voltage detection component 1201 located on a connection region of the battery assembly 1200.

The voltage detection component 1201 includes a first portion 1201a and a second portion 1201b. The first portion 1201a is covered with an insulation material, and the second portion 1201b is a copper sheet. The voltage detection component 1201 is a flexible printed circuit board. The voltage detection component 1201 may be a flexible printed circuit board of a square shape or any proper shape. In other embodiments of the present application, the second portion 1201b is a sheet made from any proper material. The second portion 1201b of the voltage detection component 1201 at least covers at least one part of the connection region of the battery assembly 1200. Referring to FIG. 17, by taking a connection region S12 as an example, the second portion 1201b of the voltage detection component 1201 at least covers at least one part of the connection region S12 of the battery assembly 1200. The connection region S12 is jointly defined by a second portion 1211b of a tab 1211 and a second portion 1213b of a tab 1213. The tab 1211 is a copper tab, and the tab 1213 is an aluminum tab. The second portion 1201b of the voltage detection component 1201, the tab 1213 and the tab 1211 are sequentially provided from top to bottom by adopting the ultrasonic welding to complete welding at one time.

Therefore, according to the embodiments of the present application, the voltage detection component may be arranged to connect to the connection region of the battery assembly, so as to realize detection of voltage provided by the present application. Furthermore, the ultrasonic welding is adopted for connection of the voltage detection component and the connection region, and the battery assembly with the voltage detection function can be obtained with a relatively simple process.

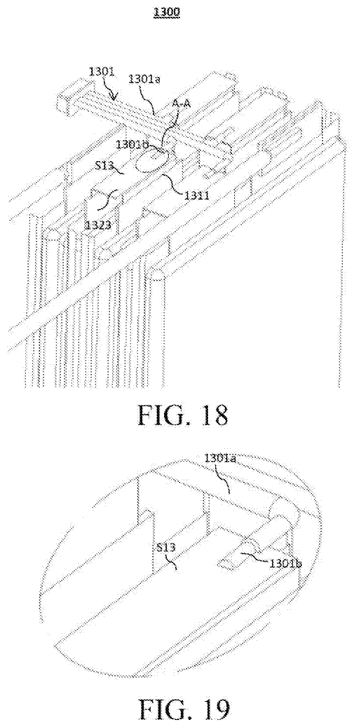

FIG. 18 shows a structural schematic diagram of a battery assembly 1300 according to another embodiment of the present application. FIG. 19 shows a partially enlarged structure diagram of a part A-A of the battery assembly 1300 shown according to FIG. 18. As shown in FIG. 18 and FIG. 19, the difference between the battery assembly 1300 shown in FIG. 18 and the embodiment shown in FIG. 16 is that: the battery assembly 1300 includes a terminal wire 1301 located above a connection region of the battery assembly 1300.

The terminal wire 1301 includes a first portion 1301a and a second portion 1301b, the first portion 1301a is covered with an insulation material, and the second portion 1301b is a cylindrical metal wire. In other embodiments of the present application, the second portion 1301b is a cylindrical metal wire made of any proper material, such as, nickel alloy, copper alloy or aluminum alloy, or the like. A second portion 1301b of the terminal wire 1301 at least covers at least one part of a connection region of the battery assembly 1200. Referring to FIG. 19, by taking the connection region S13 as an example, the second portion 1301b of the voltage detection component 1301 at least covers at least one part of the connection region S13 of the battery assembly 1300. The connection region S13 is jointly defined by a bent second portion of a tab 1311 and a bent second portion of a tab 1323. The tab 1311 is a copper tab, the tab 1323 is an aluminum tab, the ultrasonic welding may be adopted to complete one time of welding on the tab 1323 and the tab 1311 from top to bottom, and then the second portion 1301b of the terminal wire 1301 is welded to the tab 1323.

According to the embodiment of the present application, the ultrasonic welding process may be adopted to realize connection of tabs of the mutually stacked cells firstly, so as to form a series tab assembly, a parallel tab assembly and a series-parallel tab assembly. Then, the ultrasonic welding process is adopted to weld a connecting piece to the tab of the series tab assembly, the parallel tab assembly or the series-parallel tab assembly, so as to realize electrical connection of the formed series tab assembly, parallel tab assembly or series-parallel tab assembly with the external device(s). Finally, the voltage detection component such as the flexible printed circuit board or the terminal wire covers one part of a connection region of the formed series tab assembly, parallel tab assembly or series-parallel tab assembly, so as to realize voltage detection. Therefore, according to the present application, by adopting the ultrasonic welding process, a simple structure of connection of the soft-package battery with the external device(s) may be realized by a simple manufacture process. Meanwhile, the structure further includes the voltage detection component to complete the voltage detection function. Therefore, the battery assembly provided by the embodiment of the present application has multiple advantages of low production cost, simple production process, high production efficiency, strong current bearing capacity and the like.

Actually, the body of the soft-package battery assembly is relatively soft, and expands easily in charge and discharge processes. Therefore, the mechanical resistance and the mechanical working condition resistance of the soft-package battery assembly are both relatively poor. The battery assembly provided by the embodiment of the present application includes a connection region of the tab, and a special structure may be designed to protect the connection region of the tab, so as to better fix and protect the tab and the connection region of the tab, and thus the tab and the connection region of the tab provided by the embodiment of the present application are more steady in structure, and have good environment resistance, such as salt spray resistance, acid and alkali resistance, corrosion resistance and water resistance. Meanwhile, lighter overall weight of the battery assembly, lower production cost and higher production efficiency are also importance factors needing to be considered in design of the special structure for protecting the tab and the connection region of the tab.

In view of the above, the applicant performs special protection on the battery assembly provided by the embodiment of the present application, so as to further improve the safety performance of the soft-package battery assembly, prolong the service life and ensure relatively high production efficiency.

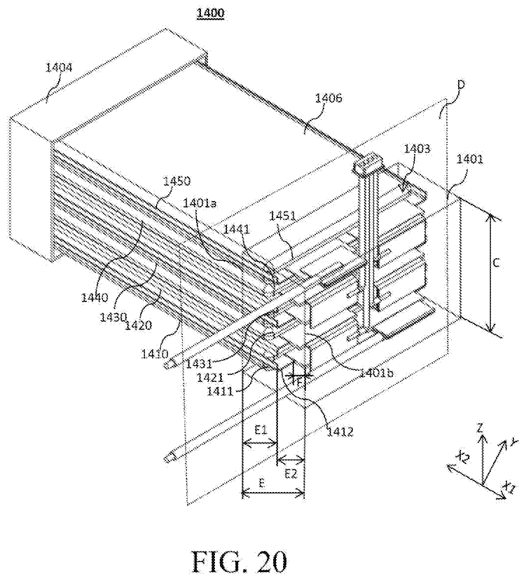

FIG. 20 shows a structure schematic diagram of a battery assembly 1400 according to another embodiment of the present application. As shown in FIG. 20, the difference between the battery assembly 1400 shown in FIG. 20 and the embodiment shown in FIG. 18 is that: the battery assembly 1400 further includes: a first insulator 1401, which covers a first end 1403 of the battery assembly 1400.

The first end 1403 is an end face on which a first end 1411 of a first cell 1410, a first end 1421 of a second cell 1420, a first end 1431 of a third cell 1430, a first end 1441 of the fourth cell 1440 and a first end 1451 of a fifth cell 1450 are located together. Main bodies of the first cell 1410, the second cell 1420, the third cell 1430, the fourth cell 1440 and the fifth cell 1450 together form a main body 1406 of the battery assembly 1400. As shown in FIG. 20, the battery assembly 1400 has a length direction extending along a X1 direction, a width direction extending along a Y direction and vertical to the length direction, and a thickness direction extending along the Z direction and vertical to the length direction and the width direction, wherein the first end 1430 is located on an end face D on which a first side of the main body 1406, that is, the outermost side of the main body 1406 along the X1 direction as shown in FIG. 20, is located.

A first tab and a second tab of the first cell 1410 as well as a first tab and a second tab of the second cell 1420 form a first set of tabs in series, a first tab and a second tab of the third cell 1430 as well as a first tab and a second tab of the fourth cell 1440 form a second set of tabs in series, and a first tab and a second tab of the fifth cell 1450 form a third set of tabs in series.

The first insulator 1401 is located in the gaps of the first set of tabs in series, the second set of tabs in series and the third set of tabs in series at the first end 1403, so that the gaps of the first cell 1410, the second cell 1420, the third cell 1430, the fourth cell 1440 and the fifth cell 1450 at the first end 1403 may be filled with the first insulator 1401, and thus the first cell 1410, the second cell 1420, the third cell 1430, the fourth cell 1440 and the fifth cell 1450 are mechanically supported well at the first end 1403. Moreover, each tab and the connection region of the tab may be covered by the first insulator 1401, so as to provide mechanical support and isolation protection from the outside for each tab and the connection region of the tab. Therefore, the overall structure of the battery assembly 1400 is relatively steady, and each tab and the connection region of the tab of the battery assembly 1400 have good environmental resistance.

The extension directions of tabs of the first cell 1410, the second cell 1420, the third cell 1430, the fourth cell 1440 and the fifth cell 1450 at the first end 1403 are defined as a first direction, and the first direction is parallel to the length extension directions of the first cell 1410, the second cell 1420, the third cell 1430, the fourth cell 1440 and the fifth cell 1450, i.e., the X1 direction in FIG. 20. A direction opposite to the first direction is defined as a second direction, i.e., the X2 direction in FIG. 20.

In the embodiment shown in FIG. 20, the first insulator 1401 covers the first end 1403, and extends along the second direction and exceeds the first end 1403 by the dimension of 3 mm. In other embodiments of the present application, the first insulator 1401 just covers the first end 1403 of the battery assembly 1400. In other embodiments of the present application, the first insulator 1401 covers the first end 1403 of the battery assembly 1400, and extends along the second direction and exceeds the first end 1403 by at least 1 mm, so as to cover a portion of the main body 1406 of the battery assembly 1400.

The dimension C of the first insulator 1401 along the Z direction is equal to 2×quantity of cell×dimension of the cell along the Z direction×expansion coefficient+dimension of the battery assembly in the Z direction. In the embodiment shown in FIG. 20, the quantity of the cells is 5, the dimension of each of the first cell 1410, the second cell 1420, the third cell 1430, the fourth cell 1440 and the fifth cell 1450 along the Z direction is 4.7 mm, and an expansion coefficient may be set as 0.1. The dimension C of the first insulator 1401 of the embodiment shown in FIG. 20 along the Z direction of the battery assembly 1400 is equal to 2×5×4.7 mm×0.1+5×4.7 mm and is equal to 23.5 mm. Selection of the expansion coefficient may be set according to difference cells. In other embodiments of the present application, the expansion coefficient is 0.05 to 0.3, preferably, 0.1 to 0.2.

Each of the first cell 1410, the second cell 1420, the third cell 1430, the fourth cell 1440 and the fifth cell 1450 has a seal edge. By taking the first cell 1410 as an example, the first cell 1410 has a first seal edge 1414, and the seal edge 1412 is parallel to the width direction of the battery assembly 1400.

The first insulator 1401 has a first edge 1041a with dimension of E along the X1 direction and parallel to the Z direction and a second edge 1041b parallel to the Z direction. A distance between the first edge 1041a and the second edge 1041b along the X1 direction is equal to dimension E. A distance from the first edge 1041a along the X1 direction to the first seal edge 1412 is E1, a distance from the first seal edge 1412 along the X1 direction to the second edge 1041b is E2, and E is equal to E1+E2. Because the dimensions of the tab, the connection region of the tab, and the connecting piece located on the connection region of the tab in the X1 direction are relatively small, the first insulator 1401 just needs to slightly cover each tab, the connection region of the tab, and the connecting piece located on the connection region of the tab, so as to ensure protection for each tab, the connection region of the tab, and the connecting piece located on the connection region of the tab. Furthermore, considering the mass of each of the first cell 1410, the second cell 1420, the third cell 1430, the fourth cell 1440 and the fifth cell 1450 and the actual use condition, E1 may be set to be greater than E2, so as to ensure that each of the first cell 1410, the second cell 1420, the third cell 1430, the fourth cell 1440 and the fifth cell 1450 is mechanically supported well by the first insulator 1401. E2 may be set to be equal to dimension F (as shown in FIG. 20) of the tab along the X1 direction+safety coefficient, wherein the safety coefficient is 1 mm. In the embodiment shown in FIG. 2, E2=2 mm+1 mm=3 mm. The safety coefficient may be set according to specific cell dimension.

The first insulator 1401 includes a first macromolecule insulation material, for example, insulation materials commonly used in the art, including epoxy resin, organic silicon resin, or polyurethane, or the like. The first insulator 1401 may cover the first end 1403 by an encapsulation process. It is worth noting that, although the first insulator 1401 shown in FIG. 20 is in a transparent state, it is only convenient for showing the internal structure of the battery assembly 1400. After the first end 1403 of the battery assembly 1400 is covered by using the encapsulation process, elements such as the tab and the connection region located on the first end 1403 and covered by the first insulator 1401 are all invisible.

By arranging the first insulator 1401 to cover the first end of the battery assembly shown by any embodiment of the present application, to fill the gap of each cell at the first end, and performing mechanical support and isolation from the outside on the tab and the connection region of the tab, the safety performance and the service life of the battery assembly provided by the embodiment of the present application are promoted. Moreover, protection for the tab and the connection region of the tab may be realized by conveniently using the encapsulation process commonly used in the art by using the first macromolecule insulation material of the insulation material commonly used in the art, such as epoxy resin, organic silicon resin, or polyurethane. Therefore, the battery assembly provided by the embodiment of the present application also has multiple advantages of simple manufacture process, low manufacture cost, high production effect and the like.

The battery assembly 1400 shown in FIG. 20 may also include a second insulator 1404, which covers a second end opposite to the first end 1403.

The second end is an end face on which a second end of the first cell 1410, a second end of the second cell 1420, a second end of the third cell 1430, a second end of the fourth cell 1440 and a second end of the fifth cell 1450 are located together. Although the second end is not shown in FIG. 20, persons skilled in the art may understand that, the second end is located on an end face, where a second side of the main body 1406, i.e., the outermost side of the main body 1406 along the X2 direction as shown in FIG. 20, is located.

In the embodiment shown in FIG. 20, the second insulator 1404 covers the second end, and extends along the first direction and exceeds the second end by the dimension of 1 mm. In other embodiments of the present application, the second insulator 1404 just covers the second end of the battery assembly 1400. In other embodiments of the present application, the second insulator 1404 covers the second end of the battery assembly 1400, and extends along the first direction and exceeds the second end by at least 1 mm, so as to cover the other portion (that is, the portion covered by the second insulator 1404) of the main body 1406 of the battery assembly 1400. The second insulator 1404 may be arranged to extend along the X1 direction and exceed the second end by a safety length, for example, 1 mm. The safety length may be set according to the specific cell dimension. The second insulator 1404 may be arranged to extend along the X2 direction and exceed the second end by a safety length, for example, 1 mm. The safety length may be set according to the specific cell dimension.

The material of the second insulator 1404 is the same as that of the first insulator 1401, for example, insulation materials commonly used in the art, including epoxy resin, organic silicon resin, or polyurethane, or the like. The second insulator 1404 may cover the second end by an encapsulation process. In other embodiments of the present application, the second insulator 1404 includes a second macromolecule insulation material, for example, silica gel. The second insulator 1404 may be connected to the second end of the battery assembly 1400 by, for example, a bonding layer (not shown in the figure) formed by glue. The second insulator 1404 is connected to the second end of the battery assembly 1400 by the bonding layer to avoid adoption of a glue filling process, and thus being beneficial for improving the production efficiency. However, compared with a conventional process that the glue filling process is adopted to connect the second insulator 1404 to the second end of the battery assembly 1400, the process that the bonding layer is adopted to connect the second insulator 1404 to the second end of the battery assembly 1400 will have poor airtightness, that is because tiny seams may be not completely filled.

When the bonding layer is adopted to enable the second insulator 1404 to just cover the second end of the battery assembly 1400, a bonding force between the bonding layer and the second end of the battery assembly 1400 is greater than a bonding force between the first insulator 1401 and the first end 1403 of the battery assembly 1400.

When the bonding layer is adopted to enable the second insulator 1404 to cover the second end of the battery assembly 1400, and the second insulator 1404 extends along the first direction and exceeds the second end, the bonding layer and the second insulator 1404 extend together, to cover the other portion of the main body 1406 of the battery assembly 1400, and a bonding force between the bonding layer and the other portion of the main body 1406 of the battery assembly 1400 is greater than a bonding force between the first insulator and the part, covered by the first insulator 1401, of the main body 1406 of the battery assembly 1400.

By arranging the second insulator 1404 to cover the second end of the battery assembly 1400, the overall mechanical resistance of the battery assembly 1400 may be further promoted. Furthermore, because the materials of the first insulator 1401 and the second insulator 1404 are small in unit mass, the overall weight of the battery assembly 1400 is relatively light.

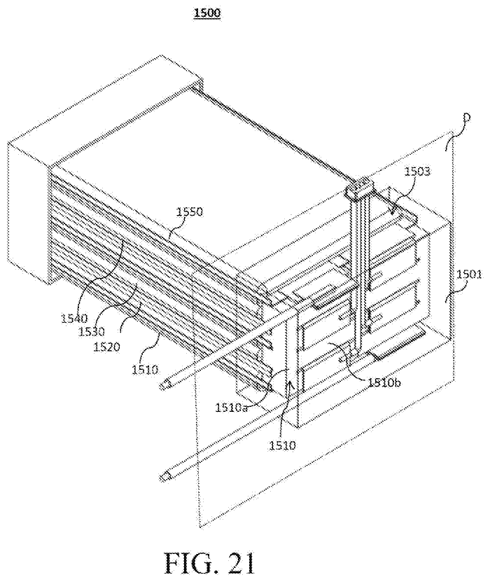

FIG. 21 shows a structure schematic diagram of a battery assembly 1500 according to another embodiment of the present application. As shown in FIG. 21, the difference between the battery assembly 1500 shown in FIG. 21 and the embodiment shown in FIG. 20 is that: the battery assembly 1500 further includes: a tab insulator 1510, which has a first part 1510a, and a second part 1510b extending from the first part 1510a. The first part 1510a and the second part 1510b of the tab insulator 1510 may be formed by a one-piece molding process.

The second part 1510b of the tab insulator 1510 is located in gaps of a first cell 1510, a second cell 1520, a third cell 1530, a fourth cell 1540 and a fifth cell 1550 at a first end 1503, so that the gaps among the tabs may be filled with the second portion 1510, and the tabs are insulated from one another. The material of the tab insulator 1510 is polypropylene. The unit mass of the tab insulator 1510 is smaller than the unit mass of the first insulator 1501, and thus, the gaps among the tabs of the first cell 1510, the second cell 1520, the third cell 1530, the fourth cell 1540 and the fifth cell 1550 are filled with the second part 1510b, the use amount of the first insulator 1501 may be reduced, and the overall weight of the battery assembly 1500 is further reduced.

Before the first insulator 1501 is arranged at the first end 1503 by adopting the glue filling process, the tab insulator 1510 may be arranged at the first end 1503 first, and thus, after the first insulator 1501 is arranged at the first end 1503 by adopting the glue filling process, a portion in the first insulator 1501 may permeate into the tab insulator 1510.

According to the embodiment of the present application, the first insulator 1501 is arranged to at least cover the first end 1503 of the battery assembly 1500, the tab insulator 1510, and the series tab assembly formed by respective tabs of the first cell 1510, the second cell 1520, the third cell 1530, the fourth cell 1540 and the fifth cell 1550, so that lighter weight of the battery assembly may be realized while the mechanical resistance and the environment resistance of the battery assembly 1500 are improved.

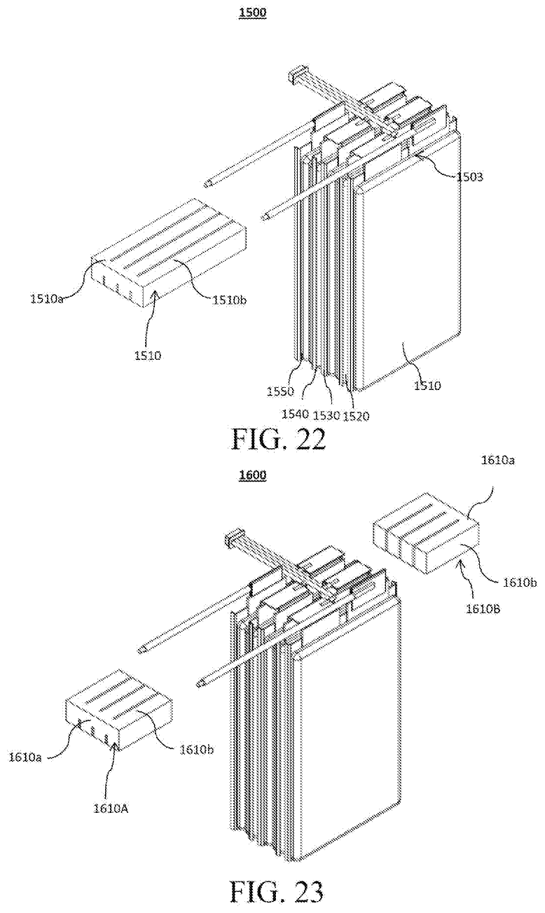

FIG. 22 shows a schematic diagram before a tab insulator 1510 is assembled to the battery assembly 1500 according to the embodiment shown in FIG. 21

Referring to FIG. 21 and FIG. 22, the second part 1510b of the tab insulator 1510 is located in gaps of the first cell 1510, the second cell 1520, the third cell 1530, the fourth cell 1540 and the fifth cell 1550 at the first end 1503, so that the gaps among the tabs may be filled with the second part 1510b, and then all the tabs are insulated from one another.

According to the embodiment of the present application, by means of the arrangement of the tab insulator 1510 with unit mass smaller than the unit mass of the first insulator 1501, not only may the tabs of the first cell 1510, the second cell 1520, the third cell 1530, the fourth cell 1540 and the fifth cell 1550 be insulated from one another, but also the use amount of the first insulator 1501 may be reduced, and therefore, the weight of the battery assembly 1500 is reduced.

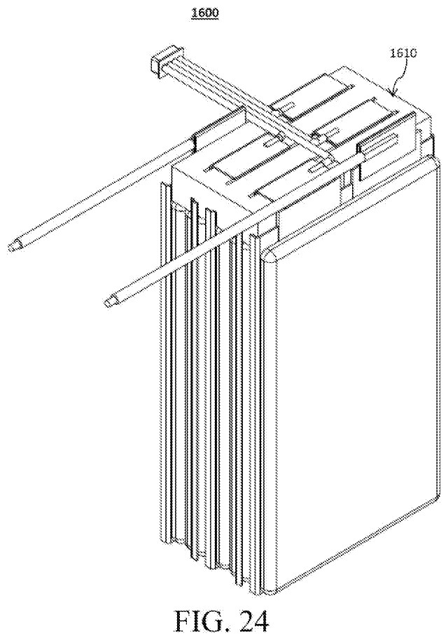

FIG. 23 shows a schematic diagram before a tab insulator 1610 is assembled to a battery assembly 1600 according to another embodiment of the present application. FIG. 24 shows a schematic diagram after the tab insulator 1610 is assembled to the battery assembly 1600 according to the embodiment shown in FIG. 23.

As shown in FIG. 23 and FIG. 24, the tab insulator 1610 is of a split structure, and includes a first tab insulator piece 1610A and a second tab insulator piece 1610B. The first tab insulator piece 1610A and the second tab insulator piece 1610B respectively have a first part 1610a, and one or more second parts 1610b extending from the first part 1610a, and the second part 1610b of the first tab insulator piece 1610A is adjacent to the second part 1610b of the second tab insulator piece 1610B. After the first tab insulator piece 1610A and the second tab insulator piece 1610B are installed to the battery assembly 1600, a gap among tabs of the battery assembly 1600 at the first end 1603 is filled with the second part 1610b of the tab insulator 1610, and thus, the tabs may be insulated from one another. A part of the tab insulator 1610 is located below the connection regions of the tabs. According to the embodiment of the present application, by using the tab insulator with unit mass smaller than the unit mass of the first insulator, the use amount of the first insulator may be reduced, and therefore, the weight of the battery assembly is reduced.

The present application also provides an electrochemical device, including the battery assembly described in any embodiment of the present application.

The technical contents and technical features of the present application have been disclosed above. However, those skilled in the art may still make replacements and modifications on the basis of the demonstrations and disclosure of the present application without departing from the spirit of the present application. Therefore, the scope of protection of the present application should not be limited to the contents disclosed in the embodiments and, instead, should include various replacements and modifications made without departing from the present application and be covered by the claims of the present application.

1. A battery assembly, comprising:
a first end;
a first cell comprising a first tab and a second tab; and
a second cell stacked with the first cell, wherein the second cell comprises a third tab and a fourth tab;
wherein the first cell and the second cell are electrically connected to form a first series tab assembly by connecting the first tab or the second tab to the third tab or the fourth tab or the first cell and the second cell are electrically connected to form a first parallel tab assembly via the first tab and/or the second tab of the first cell,
the second tab comprises a first portion extended from a body of the first cell in a direction substantially parallel to a length direction of the first cell, and a second portion extended from an end of the first portion of the second tab, and substantially perpendicular to the first portion of the second tab;
the third tab comprises a first portion extended from a body of the second cell in a direction substantially parallel to a length direction of the second cell, and a second portion extended from an end of the first portion of the third tab, and substantially perpendicular to the first portion of the third tab;
the second portion of the second tab and the second portion of the third tab are stacked and electrically connected; and
the battery assembly further comprises a first insulator, at least covering the first end and being located in a gap of the first series tab assembly or the first parallel tab assembly at the first end.

2. The battery assembly according to claim 1, wherein a connection area takes up from 30% to 95% of the surface of the second portion of the second tab facing the surface of the second portion of the third tab, wherein the connection area is an area of a surface of the second portion of the second tab that is in contact with a surface of the second portion of the second tab; or both the second portion of the second cell and the second portion of the first cell are rectangle, and a distance from a boundary of the connection region to a boundary of the second portion is smaller than about 1 mm.

3. The battery assembly according to claim 1, wherein the second tab and the third tab are connected by welding, wherein a hardness of the second tab of the first cell is greater than a hardness of the third tab of the second cell, and the second portion of the second tab is stacked on the second portion of the third tab.

4. The battery assembly according to claim 1, wherein the battery assembly further comprises one or more second series tab assemblies in series connection with the first series tab assembly, the first series tab assembly being electrically connected with the second series tab assembly by respective tabs thereon, or the second series tab assemblies being electrically connected with one another by respective tabs thereon; or the battery assembly further comprises one or more second parallel tab assemblies in series connection with the first parallel tab assembly, the first parallel tab assembly being electrically connected with the second parallel tab assembly by a first connecting piece, or the second parallel tab assemblies being electrically connected with one another by the first connecting piece.

5. The battery assembly according to claim 1, wherein the first tab and the fourth tab are respectively connected to a second connecting piece; the second connecting piece is configured for connecting the battery assembly with an external device outside the battery assembly.

6. The battery assembly according to claim 1, wherein the battery assembly further comprises a voltage detection component located on the connection region.

7. The battery assembly according to claim 1, wherein the battery assembly further comprises a second end arranged opposite to the first end, and a second insulator at least covering the second end.

8. The battery assembly according to claim 1, wherein the first insulator comprises a first macromolecule insulating material.

9. The battery assembly according to claim 7, wherein a material of the second insulator is the same as a material of the first insulator.

10. The battery assembly according to claim 7, wherein the second insulator comprises a second macromolecule insulating material.

11. The battery assembly according to claim 7, wherein the battery assembly further comprises a bonding layer located between the second insulator and the second end of the battery assembly, and a bonding strength between the bonding layer and the second end of the battery assembly is greater than a bonding strength between the first insulator and the first end of the battery assembly.

12. The battery assembly according to claim 1, wherein an extending direction of the first tab and the second tab at the first end is defined as a first direction, and the first direction is parallel to a length extension direction of the first cell, a direction opposite to the first direction is defined as a second direction, and the first insulator extends along the second direction and exceeds the first end by at least 1 mm to cover one portion of a main body of the battery assembly.

13. The battery assembly according to claim 12, wherein the battery assembly further comprises a second end disposed opposite to the first end, a second insulator at least covering the second end, and a bonding layer located between the second insulator and the second end of the battery assembly, the second insulator extending along the first direction and exceeding the second end by at least 1 mm, and the bonding layer and the second insulator extending together to cover the other portion of the main body of the battery assembly, a bonding strength between the bonding layer and the other portion of the main body of the battery assembly being greater than a bonding strength between the first insulator and the one portion of the main body of the battery assembly.

14. The battery assembly according to claim 1, wherein the battery assembly further comprises a tab insulator, having a first part, and a second part extending from the first part, the second part of the tab insulator being located in the gap of the first series tab assembly or the first parallel tab assembly at the first end.

15. The battery assembly according to claim 14, wherein a unit mass of the tab insulator is smaller than a unit mass of the first insulator.

16. The battery assembly according to claim 14, wherein a part of the first insulator is located in the tab insulator.

17. An electrochemical device including a battery assembly, the battery assembly comprising:
a first end;
a first cell;
a second cell, stacked with the first cell, the first cell and the second cell each comprises a first tab and a second tab; and
wherein one of the first tab or the second tab of the first cell is configured to be electrically connected with one of the first tab or the second tab of the second cell to form a first series tab assembly, or the first tab and the second tab of the first cell are configured to be electrically connected with the first tab and the second tab of the second cell respectively to form a first parallel tab assembly, the first tab and the second tab each comprises a first portion and a second portion, the first portion and the second portion are connected and form a bent shape, and the second portion of the first cell and the second portion of the second cell are stacked and electrically connected, the overlapping part of the second portion of the second cell and the second portion of the first cell form a connection region,
the battery assembly further comprises a first insulator, at least covering the first end and located in a gap of the first series tab assembly or the first parallel tab assembly at the first end.

18. The electrochemical device according to claim 17, wherein the electrochemical device further comprises a tab insulator, having a first part, and a second part extending from the first part, the second part of the tab insulator being located in the gap of the first series tab assembly or the first parallel tab assembly at the first end.

19. The electrochemical device according to claim 18, wherein a unit mass of the tab insulator is smaller than a unit mass of the first insulator.

20. The electrochemical device according to claim 18, wherein a part of the first insulator is located in the tab insulator.
